(19) United States
(12) Patent Application Publication
(10) Pub. No.: US 2026/0097371 A1
(43) Pub. Date: Apr. 9, 2026

(54) MIXING DEVICE AND MIXING SYSTEM

(71) Applicant: National Kaohsiung University of Science and Technology, Kaohsiung City (TW)

(72) Inventor: CHENG-TA YANG, Kaohsiung City (TW)

(73) Assignee: National Kaohsiung University of Science and Technology, Kaohsiung City (TW)

(21) Appl. No.: 19/347,758

(22) Filed: Oct. 2, 2025

(30) Foreign Application Priority Data
Oct. 3, 2024 (TW) 113137698

(51) Int. Cl. B01F 25/314; B01F 35/00; B01F 25/00

(52) U.S. Cl. CPC B01F 25/3141; B01F 35/55; B01F 2025/93

(57) ABSTRACT

A mixing device includes a fluid input portion, suitable for receiving at least one fluid to be mixed, the fluid input portion including at least one fluid input pipe; and a fluid mixing portion, communicated to the fluid input portion, the fluid mixing portion including a fluid mixing pipe, communicated to the at least one fluid input pipe; and a passive shaking deflector, arranged in the fluid mixing pipe; wherein the passive shaking deflector is driven to shake by the fluid to be mixed flowing through the passive shaking deflector. The mixing device is suitable for improving mixing efficiency in pipes without external power.

### CROSS-REFERENCE TO RELATED APPLICATION

This non-provisional application claims priority under 35 U.S.C. § 119(a) on Patent Application No(s). 113137698 filed in Taiwan, R.O.C. on Oct. 03, 2024, the entire contents of which are hereby incorporated by reference.

### BACKGROUND OF THE INVENTION

### 1. Field of the Invention

The present disclosure provides a mixing device and a mixing system, and in particular a passive mixing device and mixing system that is simple in design and does not require additional power.

### 2. Description of the Related Art

Fluid mixing, particularly mixing of different solutes and solvents, is a crucial process in biochemistry. For example, in the future development of biomedical chips, achieving efficient mixing in a short time with a simple structure is a key research topic.

Existing fluid mixing devices may generally be categorized as passive mixing devices or active mixing devices.

The design of common passive mixing devices involves flowing two or more fluids of different substances through the mixing device, mixing them with the aid of structures such as obstructions or bends without requiring additional power input. However, this method has low mixing efficiency and requires a long time to achieve complete mixing, making it unsuitable for biomedical applications.

In contrast, the design of common active mixing devices, such as those used in biology, chemistry, medicine and other fields with micron and nanometer spatial scales, also uses methods such as pressure pump injection, electrical attraction, or the use of large measuring cups, magnetic rods or magnetic rotators. Different substances are placed in a large container, and the magnetic rotator is activated to drive the magnetic rod to rotate in the liquid to achieve a mixing reaction. However, due to the need for an additional power mechanism or the need for a larger fluid container, there are often problems such as excessive volume or the need to use a large amount of fluid material. It also has problems such as uneven product temperature distribution and long time required. In addition, active mixing devices driven by active power, such as electricity, also consume energy to achieve the mixing effect. If power is unstable or power outages occur, mixing may not be possible. Furthermore, active mixing devices driven by active power, such as electricity, will apply energy to the fluid, causing the temperature of the fluid to rise. This can easily cause a negative impact on fluids that are sensitive to temperature changes.

On the other hand, mixing devices in the field of micron and nanometer spatial scales conventionally carry out mixing based on the pipe layout distribution method and angle design of micro-channels. However, the mixing effect of such designs is fixed after the mixing device is manufactured and cannot be adjusted according to user needs.

### BRIEF SUMMARY OF THE INVENTION

In this regard, in order to solve the problems of poor mixing efficiency and long action time of the passive mixing device with a simple structural design, or the active mixing device requiring additional power or having a larger-volume power device that occupies a larger use space or causing a negative impact due to the temperature increase of fluids sensitive to temperature changes, or the lack of flexible adjustment of mixing requirements once the microchannel mixing device is manufactured, etc.

One of the purposes of the present disclosure is to provide a mixing device and a mixing system thereof with an improved mixing rate. The fluid to be mixed passes through a passive shaking deflector in the mixing device, so that the structure of the passive shaking deflector generates natural vibration due to the passage of the fluid, and thus the surrounding fluid can be quickly mixed due to the vibration without the need for additional mixing power while retaining the adjustment flexibility of the mixing device.

One aspect of the present disclosure provides a mixing device, including: a fluid input portion, suitable for receiving at least one fluid to be mixed, the fluid input portion including: at least one fluid input pipe; and a fluid mixing portion, communicated to the fluid input portion, the fluid mixing portion including: a fluid mixing pipe, communicated to the at least one fluid input pipe; and a passive shaking deflector, arranged in the fluid mixing pipe; wherein the passive shaking deflector is driven to shake by the fluid to be mixed flowing through the passive shaking deflector.

As the mixing device described above, the passive shaking deflector includes: a supporting base, disposed on a wall of the fluid mixing pipe; and a shaking spoiler, connected to the supporting base; wherein the volume of the shaking spoiler is larger than the volume of the supporting base, and the shaking spoiler has a larger fluid contact area compared to the supporting base.

As the mixing device described above, the shaking spoiler includes a front spoiler end, proximal to a location where the at least one fluid to be mixed is received; and a back spoiler end, distal to the location where the at least one fluid to be mixed is received; wherein in a direction from the front spoiler end toward the back spoiler end, the shaking spoiler has a first arc surface with a gradually expanding thickness and a second arc surface with a gradually shrinking thickness that is continuous with the first arc surface on at least one side.

As the mixing device described above, the mixing device further includes a fixed deflector, disposed in the fluid mixing pipe and adjacently spaced apart from the passive shaking deflector.

As the mixing device described above, there are two passive shaking deflectors, respectively adjacently spaced apart from both sides of the fixed deflector.

As the mixing device described above, the shaking spoiler includes a front spoiler end, proximal to a location where the at least one fluid to be mixed is received; and a back spoiler end, distal to the location where the at least one fluid to be mixed is received; wherein in a direction from the front spoiler end toward the back spoiler end, the shaking spoiler has a first arc surface with a gradually expanding thickness and a second arc surface with a gradually shrinking thickness that is continuous with the first arc surface on at least one side.

As the mixing device described above, the first arc surface and the second arc surface are formed on a side of the shaking spoiler adjacent to the fixed deflector.

As the mixing device described above, the first arc surface and the second arc surface are formed on a side of the shaking spoiler away from the fixed deflector.

As the mixing device described above, there are a plurality of passive shaking deflectors, which are arranged linearly adjacent to or surrounding the fluid mixing pipe.

As the mixing device described above, the passive shaking deflector is removably mounted in the fluid mixing pipe.

As the mixing device described above, the fluid mixing pipe has at least one slot configured to accommodate and fix the supporting base of the passive shaking deflector.

As the mixing device described above, at least a portion of the fluid mixing pipe is removable.

Another aspect of the present disclosure provides a mixing system, including a mixing tank; at least two mixing devices as described above; wherein the fluid mixing portions of the at least two mixing devices are communicated to the mixing tank via at least two openings, wherein the opening axis directions of the at least two openings are non-coaxial with each other.

As the mixing system described above, the opening axis directions of the at least two openings are located on opposite sides of the center of the mixing tank.

By placing the passive shaking deflectors within a fluid mixing pipe, the mixing device and mixing system of the present disclosure can utilize the fluid pressure difference generated when the fluid to be mixed flows near the passive shaking deflector to cause the passive shaking deflector to shake due to the natural vibration generated by its configuration, thereby improving the fluid mixing effect through its natural vibration. In addition, through the configuration of the passive shaking deflector with a smaller supporting base and a larger shaking spoiler, since the supporting base is narrow and thin, when the fluid flows through the passive shaking deflector, it will easily cause natural shaking generated by the fluid flowing through it, and the arc surface configuration on different sides further provides a flow channel for the fluid to be squeezed.

Through the fixed deflector in one embodiment and the spaced flow channels and configuration between it and the passive shaking deflectors, the vibration and fluid mixing effect of adjacent passive shaking deflectors can be further improved.

Through the removable passive shaking deflectors in one embodiment, the number of passive shaking deflectors in the mixing device can be freely adjusted and the passive shaking deflectors can be freely configured in combination in multiple directions, thereby adjusting the mixing rate according to the needs to achieve better and more appropriate fluid mixing effects.

### BRIEF DESCRIPTION OF THE DRAWINGS

FIG. 1 shows a schematic view of an arrangement of a mixing device in one embodiment of the present disclosure.

FIG. 2 shows a schematic view of an arrangement of the passive shaking deflector in one embodiment of the present disclosure.

FIG. 3 shows a schematic view of a configuration of the passive shaking deflector in one embodiment of the present disclosure.

FIG. 4 shows a schematic view of an arrangement of a mixing device including a fixed deflector and adjacent passive shaking deflectors in one embodiment of the present disclosure.

FIG. 5A shows a schematic view of a configuration and arrangement of a fixed deflector and adjacent passive shaking deflectors in one embodiment of the present disclosure.

FIG. 5B shows a schematic view of a configuration and arrangement of a fixed deflector and adjacent passive shaking deflectors in one embodiment of the present disclosure.

FIG. 6 shows a schematic view of an arrangement of a plurality of passive shaking deflectors in one embodiment of the present disclosure.

FIG. 7 shows a schematic view of an arrangement of a fluid mixing pipe having a slot and the fluid mixing pipe being partially removable in one embodiment of the present disclosure.

FIG. 8 shows a schematic view of an arrangement of the mixing system in one embodiment of the present disclosure.

FIG. 9 shows a schematic view of a relative arrangement of the mixing tank and the mixing devices of the mixing system in one embodiment of the disclosure.

### DETAILED DESCRIPTION OF THE INVENTION

To describe the technical content of the present disclosure in detail, further description will be provided below in combination with the embodiments and the drawings. It should be noted that in the content of the disclosure, terms such as “first”, “second” and “third” are used to distinguish differences between elements, but are not used to limit the elements themselves or indicate a specific ordering of the elements. Furthermore, in the context of the disclosure, the article “a” or “an” refers to one element or to more than one element unless a specific number is specified.

To facilitate understanding of the purpose, characteristics and effects of the present disclosure, the following specific embodiments together with the attached drawings for the detailed description of the present disclosure are provided as below.

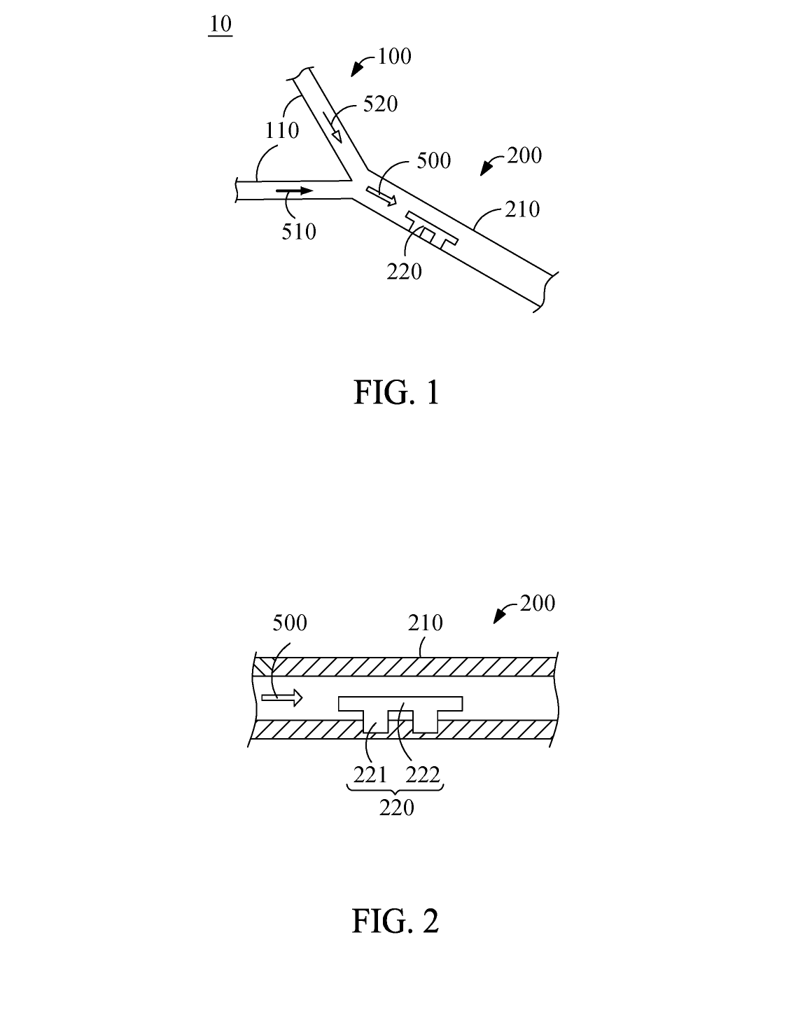

FIG. 1 shows a schematic view of an arrangement of a mixing device 10 in one embodiment of the present disclosure. The mixing device 10 according to one embodiment of the present disclosure includes a fluid input portion 100 and a fluid mixing portion 200.

Referring to FIG. 1, in one embodiment, the fluid input portion 100 is suitable to receive at least one fluid to be mixed (e.g., a first fluid 510 to be mixed and a second fluid 520 to be mixed in FIG. 1). The fluid input portion 100 includes at least one fluid input pipe 110. The fluid mixing portion 200 is communicated to the fluid input portion 100, the fluid mixing portion 200 includes a fluid mixing pipe 210 and a passive shaking deflector 220. The fluid mixing pipe 210 is communicated to the at least one fluid input pipe 110. The passive shaking deflector 220 is disposed in the fluid mixing pipe 210. Among them, the passive shaking deflector 220 is driven to shake by the fluid 500 to be mixed flowing through the passive shaking deflector 220.

In one embodiment, the fluid 500 to be mixed received by the fluid input portion 100 may be one, two, or a plurality of types of fluids, and the fluids 500 received to be mixed may come from one or a plurality of fluid input pipes 110. The fluids 500 to be mixed, the first fluid 510 to be mixed, and the second fluid 520 to be mixed are merely illustrative. The mixing device 10 may also receive a single fluid input from a single fluid input pipe 110. The fluids may include one or more substances, etc., and the mixing device 10 may be used to mix the fluids. The embodiments of the present disclosure are not limited to inputting multiple fluids. Among them, the fluids are not limited to liquids; solids, gases, or other forms having fluid physical properties are all aspects of the fluids described in the present embodiment.

In one embodiment, the fluid mixing portion 200 is communicated to the fluid input portion 100, and the fluid mixing portion 200 includes a fluid mixing pipe 210 and a passive shaking deflector 220 disposed therein. The fluid mixing pipe 210 described herein refers to any pipe capable of accommodating the flow of fluid, the shape of which is not limited to a circular hole diameter or a straight tube, and the dimensions of which do not necessarily have to be uniform or the same. The fluid mixing pipe 210 shown in FIG. 1 is for illustration only. For example, the passive shaking deflector 220 is disposed on the pipe wall within the fluid mixing pipe 210. It may be mounted using fixed or removably fixed means such as embedding, buckling, engaging, integrally forming, or adhering. The so-called passive shaking deflector 220 refers to the passive shaking deflector 220 which is driven to shake by the fluid 500 to be mixed flowing through the passive shaking deflector 220. For example, due to the setting of the passive shaking deflector 220, the cross-sectional area through which the fluid 500 to be mixed can flow in the fluid mixing pipe 210 is reduced and/or the length through which the fluid needs to flow is different, thereby causing changes in flow velocity and pressure. For example, when the fluid 500 to be mixed flows through the passive shaking deflector 220, a pressure difference is caused in the adjacent area of the passive shaking deflector 220, which pushes and vibrates the passive shaking deflector 220, thereby causing the passive shaking deflector 220 to shake, causing vibration and turbulence to the surrounding fluid 500 to be mixed, thereby achieving the effect of improving the mixing efficiency. Compared to conventional passive mixing structures that use simple bends, angles, and obstructions to create flow changes, the mixing device 10 of one embodiment of the present disclosure can further provide element vibration to further provide dynamic (vibration) mixing beyond the simple fixed structure in the unpowered mixing device 10, thereby improving mixing efficiency. In one embodiment, the mixing device 10 may include a plurality of fluid mixing portions 200. The plurality of fluid mixing portions 200 can be connected and combined with each other in series or parallel, or the like. The fluid mixing portions 200 of different sizes may also be connected and combined, for example, multiple smaller-sized fluid mixing portions 200 may be converged and connected to a larger-sized fluid mixing portion 200, etc., to achieve a staged mixing effect in multi-stage.

FIG. 2 shows a schematic view of an arrangement of the passive shaking deflector 220 in one embodiment of the present disclosure. In one embodiment of the present disclosure, the passive shaking deflector 220 includes a supporting base 221 and a shaking spoiler 222.

Referring to FIG. 2, in one embodiment, the supporting base 221 of the passive shaking deflector 220 in the fluid mixing portion 200 is arranged on the pipe wall of the fluid mixing pipe 210. As shown in FIG. 2, the pipe wall of the fluid mixing pipe 210 has a thickness for the supporting base 221 to be set, and the pipe wall of the fluid mixing pipe 210 may, for example, have a slot for the supporting base 221 to be engaged and set. The shaking spoiler 222 is connected to the supporting base 221, wherein the volume of the shaking spoiler 222 is greater than the volume of the supporting base 221, and the shaking spoiler 222 has a larger fluid contact area compared to the supporting base 221, that is, from the perspective of the plane in which the passive shaking deflector 220 is disposed on the fluid mixing pipe 210, the cross-sectional area of the shaking spoiler 222 is greater than the cross-sectional area of the supporting base 221, that is, the passive shaking deflector 220 forms a structural configuration in which the shaking spoiler 222 is relatively large and the supporting base 221 is relatively small, so that the passive shaking deflector 220 is easily affected by the flow of the fluid 500 to be mixed and vibrates. For example, when the fluid 500 to be mixed flows through both sides of the passive shaking deflector 220, the pressure difference due to the different pressures on both sides of the passive shaking deflector 220 causes the vibration of the passive shaking deflector 220.

In one embodiment, the supporting base 221 may be one or more, and is not limited to the two columns shown in FIG. 2. Any structural configuration of the passive shaking deflector 220 that forms a larger shaking spoiler 222 and a smaller supporting base 221 that is easy to vibrate is the purpose of the present disclosure. In one embodiment, the shaking spoiler 222 may also have a streamlined appearance. In one embodiment, for example, as shown in FIG. 2, there may be a gap between the supporting base 221 and the supporting base 221. It should be noted that the relationship between the supporting base 221 and the shaking spoiler 222 is not limited to the above. The supporting base 221 is intended to be a support for supporting the shaking spoiler 222 to vibrate above. As long as it does not hinder the structural vibration of the shaking spoiler 222 and allows the shaking spoiler 222 to vibrate freely, the supporting base 221 may be in the shape of a sheet, a column, etc., and is not limited thereto. In one embodiment, the shaking spoiler 222 may also be “below” the supporting base 221, and the two are reversed up and down, that is, like a chandelier, the supporting base 221 becomes a supporting mechanism for the shaking spoiler 222 to be hung upside down.

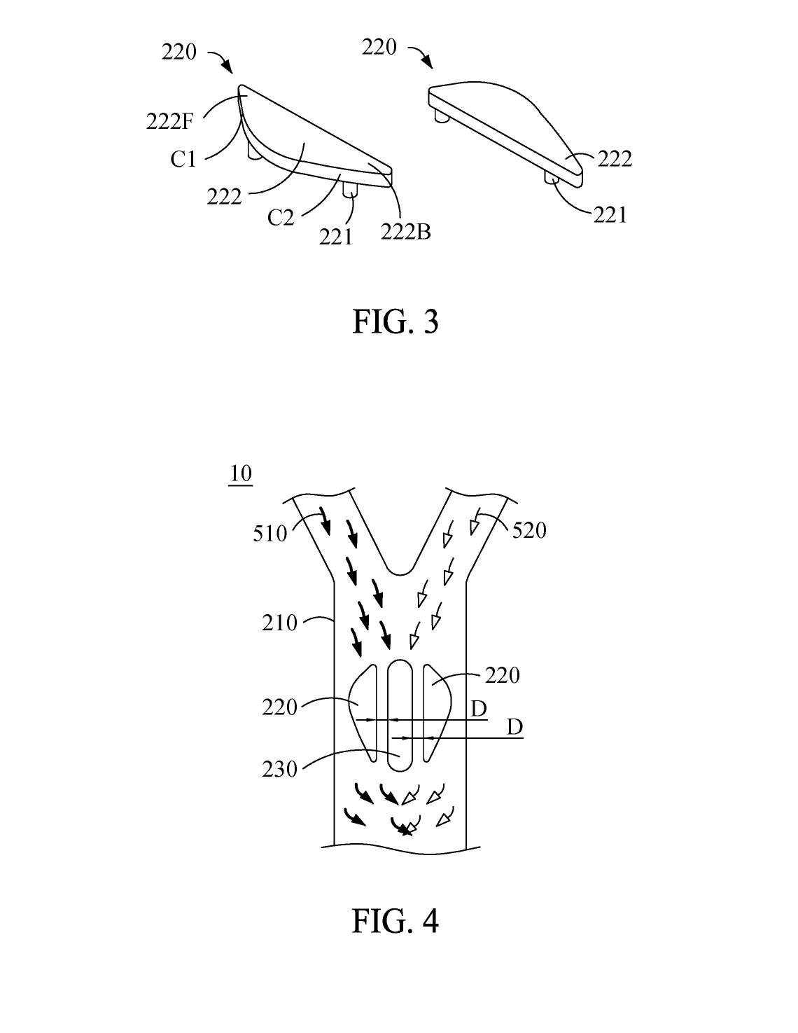

FIG. 3 shows a schematic view of a configuration of the passive shaking deflector 220 in one embodiment of the present disclosure. The passive shaking deflector 220 includes but is not limited to the type of configuration shown in FIG. 3. In one embodiment, the shaking spoiler 222 of the passive shaking deflector 220 includes a front spoiler end 222F proximal to a location where the fluid 500 to be mixed is received, and a back spoiler end 222B distal to the location where the fluid 500 to be mixed is received. Among them, in the shaking spoiler 222, the fluid 500 to be mixed flows from the front spoiler end 222F toward the back spoiler end 222B. The shaking spoiler 222 has a first arc surface C1 with a gradually expanding thickness and a second arc surface C2 with a gradually shrinking thickness that is continuous with the first arc surface C1 on at least one side. The configuration of the shaking spoiler 222 can also be called an airfoil. In this way, through the arrangement, combination and matching of the first arc surface C1 and the second arc surface C2 with varying thickness on the side surface or the flat side surface, the fluids on both sides of the shaking spoiler 222 of the passive shaking deflector 220 can produce different flow velocities and pressure differences, thereby making it easier for the passive shaking deflector 220 to vibrate when the fluid flows through, causing the fluid to produce turbulence, thereby improving the fluid mixing efficiency. As shown in FIG. 3, two different configurations of the shaking spoiler 222 of the passive shaking deflector 220 are taken as examples. The left side is a passive shaking deflector 220 with a first arc surface C1 and a second arc surface C2 with varying thickness on one side and a flat surface on the other side; the right side is a passive shaking deflector 220 that is symmetrical to the left side, and the opposite side of which has a first arc surface C1 and a second arc surface C2 with varying thickness, and the passive shaking deflector 220 has a flat surface on one side. In addition, as can be seen in FIG. 3, the supporting base 221 has a smaller volume and cross-sectional area compared to the shaking spoiler 222 and there is a pressure difference on both sides of the shaking spoiler 222, so that the passive shaking deflector 220 can be an easy-to-vibrate structure. However, the configuration of the shaking spoiler 222 of the passive shaking deflector 220 is not limited thereto. Any configuration that can generate a pressure difference on different sides of the passive shaking deflector 220 and make it easy to vibrate is within the scope of the present disclosure.

FIG. 4 shows a schematic view of an arrangement of a mixing device 10 including a fixed deflector 230 and adjacent passive shaking deflectors 220 in one embodiment of the present disclosure. In one embodiment, the mixing device 10 of the present disclosure further includes a fixed deflector 230, which is disposed in the fluid mixing pipe 210 and is adjacently spaced apart from the passive shaking deflector 220. The adjacent space refers to a space D between the fixed deflector 230 and the passive shaking deflector 220, i.e., the space D provides a flow channel for the fluid to pass through. In one embodiment, there are two passive shaking deflectors 220, which are respectively adjacently spaced apart and disposed on both sides of the fixed deflector 230, as shown in FIG. 4. In one embodiment, a fixed deflector 230 is provided between a pair of passive shaking deflectors 220, and guiding channels for fluid to pass through are formed between the two passive shaking deflectors 220 and the fixed deflector 230. When the fluid (for example, the first fluid 510 to be mixed and the second fluid 520 to be mixed) flows through the passive shaking deflectors 220 and the fixed deflector 230, the pair of passive shaking deflectors 220 are squeezed by the fluid in the guiding channels, making it easy for the two passive shaking deflectors 220 to swing left and right relative to the fixed deflector 230, thereby achieving an accelerated mixing effect of the fluid (for example, the first fluid 510 to be mixed and the second fluid 520 to be mixed) in and on both sides of the guiding channel. Compared to a simple passive shaking deflector 220, a combination of the passive shaking deflector 220 and the fixed deflector 230 has a higher vibration effect and fluid mixing efficiency because the space and configuration of the flow channel are more limited and the flow velocity changes more.

In one embodiment, the left and right spaces D may be the same or different. According to different vibration and shaking requirements, spaces D of different flow channel can be designed to adjust the mixing efficiency.

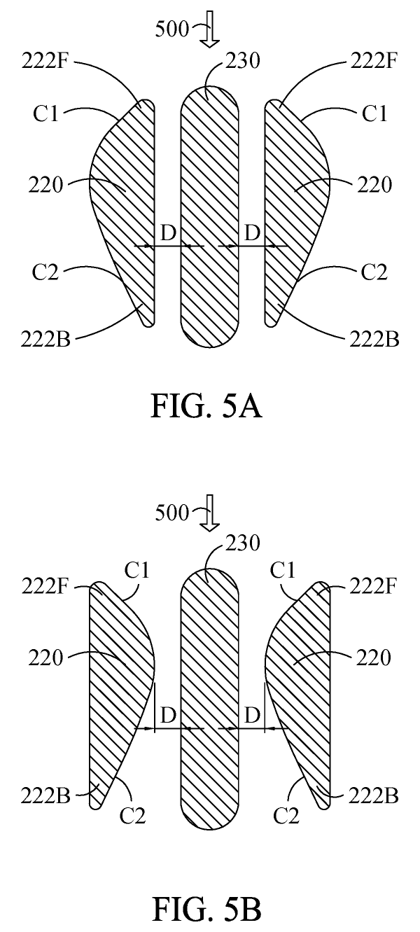

FIG. 5A shows a schematic view of a configuration and arrangement of a fixed deflector 230 and adjacent passive shaking deflectors 220 in one embodiment of the present disclosure; FIG. 5B shows a schematic view of a configuration and arrangement of a fixed deflector 230 and adjacent passive shaking deflectors 220 in another embodiment of the present disclosure. In one embodiment, the shaking spoiler 222 of the passive shaking deflector 220 also includes a front spoiler end 222F proximal to a location where the fluid 500 to be mixed is received, and a back spoiler end 222B distal to the location where the fluid 500 to be mixed is received. In a direction from the front spoiler end 222F of the shaking spoiler 222 toward the back spoiler end 222B (i.e., in the flow direction of the fluid 500 to be mixed), the shaking spoiler 222 includes a first arc surface C1 with a gradually expanding thickness and a second arc surface C2 with a gradually shrinking thickness that is continuous with the first arc surface C1 on at least one side. In this way, through the arrangement, combination and matching of the first arc surface C1 and the second arc surface C2 with varying thickness on the side surface of the passive shaking deflector 220 at both sides or the flat side surface, with the aid of the central fixed deflector 230, the fluids on both sides of the shaking spoiler 222 of the passive shaking deflector 220 can produce different flow velocities and pressure differences, thereby making it easier for the passive shaking deflector 220 to vibrate when the fluid flows through, so as to achieve shaking due to vibration, causing the fluid to produce turbulence, thereby improving the fluid mixing efficiency. In one embodiment, as shown in FIG. 5A, the side surface of the passive shaking deflector 220 with the gradually thickness-varying first arc surface C1 and second arc surface C2 is located on the outside away from the fixed deflector 230, while the side surface adjacent to the fixed deflector 230 is a flat surface, and the flow channel is a uniform space D. In one embodiment, as shown in FIG. 5B, the side surface of the passive shaking deflector 220 with the gradually thickness-varying first arc surface C1 and second arc surface C2 is located on the inner side adjacent to the fixed deflector 230, and the flow channel is a gradually varying space D from wide to narrow and then wide, while the side surface away from the fixed deflector 230 is a flat surface. It should be noted that the flat surface is not necessarily a plane and may, in fact, be a slightly flat surface with curvature or a curve surface. The flat surface refers to a surface that is relatively flat compared to the first arc surface C1 and/or second arc surface C2. However, as long as the flow length of the fluid flowing through the two sides of the passive shaking deflector 220 is different, it is sufficient.

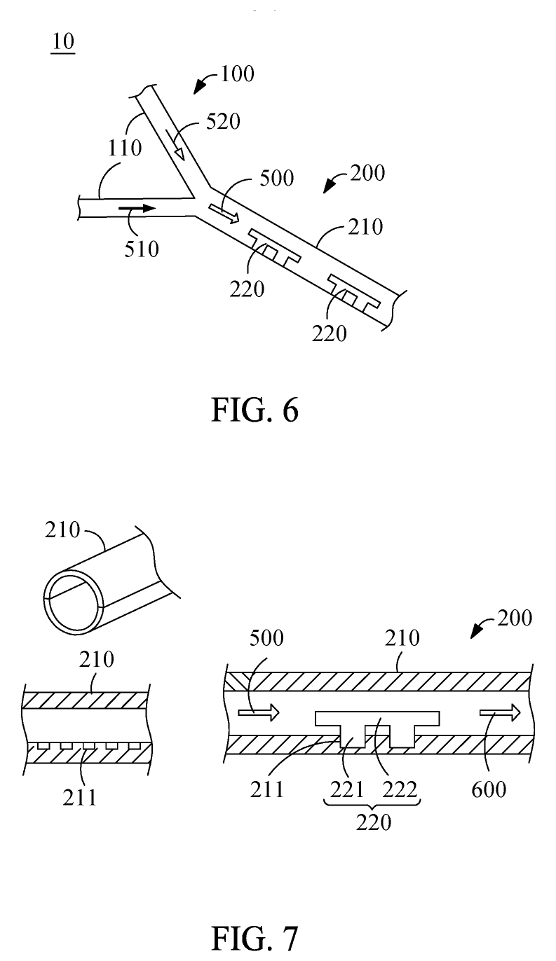

FIG. 6 shows a schematic view of an arrangement of a plurality of passive shaking deflectors 220 in one embodiment of the present disclosure. In one embodiment, the mixing device 10 may have a combination of a plurality of passive shaking deflectors 220. In one embodiment, the mixing device 10 may have a combination of a plurality of passive shaking deflectors 220 and fixed deflectors 230 in any combination of the aforementioned aspects to increase mixing efficiency throughout the fluid mixing pipe 210, rather than being limited to achieving a vibration mixing effect at only one location.

In one embodiment, the combination of the plurality of passive shaking deflectors 220 or passive shaking deflectors 220 and fixed deflectors 230 in any combination of the aforementioned aspects may be arranged in a straight line and positioned in the same orientation, as shown in FIG. 6. In one embodiment, the combination of the plurality of passive shaking deflectors 220 or passive shaking deflectors 220 and fixed deflectors 230 in any combination of the aforementioned aspects may be arranged in a circumferential staggered manner, for example, one group of the combination of the passive shaking deflectors 220 or the passive shaking deflectors 220 and the fixed deflectors 230 is arranged on one side of the fluid mixing pipe 210, and the other group of the combination of the passive shaking deflectors 220 or the passive shaking deflectors 220 and the fixed deflectors 230 is arranged on the other side of the fluid mixing pipe 210, in order to meet the mixing requirements of different fluids to be mixed. For example, some fluids may have higher viscosity, if the combinations of the passive shaking deflectors 220 or the passive shaking deflectors 220 and the fixed deflectors 230 are all located on the same side, some high-viscosity fluids may have uneven density due to gravity or the distribution of the passive shaking deflectors 220. At this time, the combinations of the passive shaking deflectors 220 or the passive shaking deflectors 220 and the fixed deflectors 230 arranged on different sides or in different orientations can better mix such fluids.

FIG. 7 shows a schematic view of an arrangement of a fluid mixing pipe 210 having a slot 211 and the fluid mixing pipe 210 being partially removable in one embodiment of the present disclosure. In one embodiment, the passive shaking deflector 220 is removably mounted on the fluid mixing pipe 210. In one embodiment, the fluid mixing pipe 210 has at least one slot 211 configured to accommodate and fix the supporting base 221 of the passive shaking deflector 220, and also to accommodate and set up the fixed deflector 230, as shown in the lower left and right schematic views of FIG. 7. In one embodiment, at least a portion of the fluid mixing pipe 210 is removable, as shown in the upper left schematic view of the arrangement of FIG. 7. In this way, through the arrangement of one or more slots 211, even after the mixing device 10 is processed and completed, the number of passive shaking deflectors 220 or the combination with the fixed deflectors 230 can be adjusted according to the increase or decrease of the use needs, so as to increase the flexibility of the use of the mixing device 10. In addition, through the partially removable fluid mixing pipe 210, such as a cover using buckles or other structures, the fluid mixing pipe 210 can be easily opened to flexibly and freely install or remove the passive shaking deflectors 220 or the combination with the fixed deflectors 230.

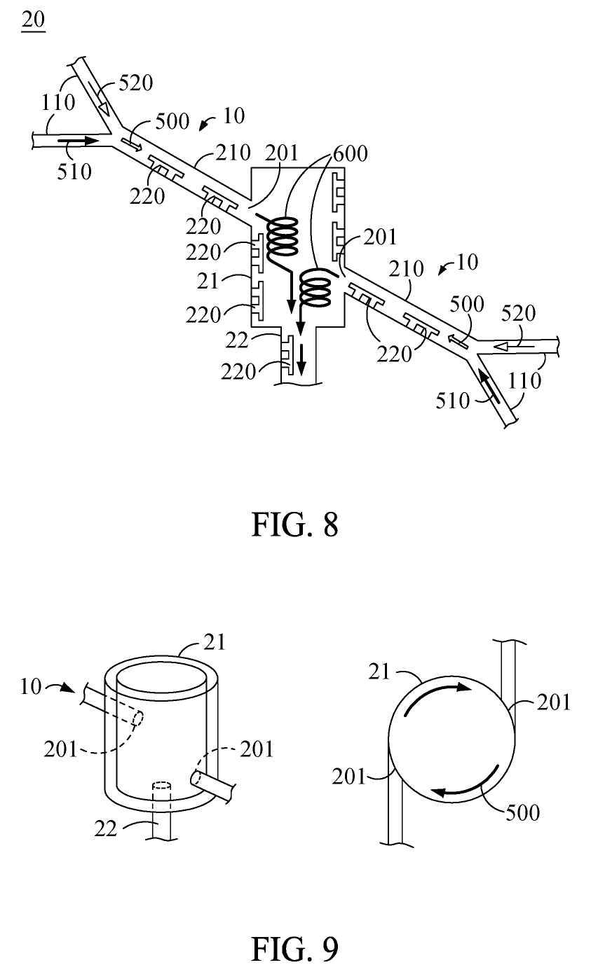

FIG. 8 shows a schematic view of an arrangement of the mixing system 20 in one embodiment of the present disclosure; FIG. 9 shows a schematic view of a relative arrangement of the mixing tank 21 and the mixing devices 10 of the mixing system 20 in one embodiment of the disclosure. The left side of FIG. 9 is a three-dimensional schematic view of the mixing tank 21 communicating with the mixing devices 10, and the right side of FIG. 9 is a top view of the mixing tank 21 communicating with the mixing devices 10.

Another aspect of the present disclosure provides a mixing system 20, as shown in FIG. 8. The mixing system 20 includes a mixing tank 21 and at least two mixing devices 10 as described above. In one embodiment, the passive shaking deflectors 220 may be also provided on the walls of the mixing tank 21 and the outlet 22 at the bottom. The fluid mixing portions 200 of the at least two mixing devices 10 are communicated to the mixing tank 21 via at least two openings 201. The opening axis directions of the at least two openings 201 are non-coaxial with each other, i.e., the axis extension directions of the pipes of the at least two openings 201 are non-coaxial. In other words, the locations where the at least two mixing devices 10 communicated to the mixing tank 21 are staggered, so that the fluid 500 to be mixed flowing into the mixing tank 21 can be evenly mixed in the mixing tank 21, and thus the fluids that have been mixed in the pipes of the mixing devices 10 can be further mixed in the mixing tank 21. In one embodiment, the mixing tank 21 is provided with an outlet 22 at the bottom, allowing the uniformly mixed fluid 600 to be naturally discharged through the outlet 22. In one embodiment, as shown in FIG. 9, the opening axis directions of the at least two openings 201 are located on opposite sides of the center of the mixing tank 21. That is, the at least two openings 201 are staggered so that the mixed fluid 600 flowing into the mixing tank 21 can be uniformly mixed or form a vortex. In one embodiment, the at least two openings 201 may be staggered to be located at different heights.

In summary, by placing the passive shaking deflectors within a fluid mixing pipe, the mixing device and mixing system of the present disclosure can utilize the fluid pressure difference generated when the fluid to be mixed flows through the two side surfaces of the passive shaking deflector to cause the passive shaking deflector to shake due to the natural vibration generated by its configuration, thereby improving the fluid mixing effect through its natural vibration. In addition, the configuration of the passive shaking deflector with a smaller supporting base and a larger shaking spoiler facilitates the natural shaking generated by the fluid flowing through it, and the arc surface configuration on different sides further provides a flow channel for the fluid to be squeezed.

In addition, through the fixed deflector in one embodiment and the spaced flow channels between it and the passive shaking deflectors and the configuration, the vibration and fluid mixing effect of adjacent passive shaking deflectors can be further improved.

Furthermore, through the removable passive shaking deflectors in one embodiment, the number of passive shaking deflectors in the mixing device can be freely adjusted and the passive shaking deflectors can be freely configured in combination in multiple directions, thereby adjusting the mixing rate according to user needs. Compared to conventional mixers, mixing chips, and microfluidic mixing chips, whose mixing rates are fixed after manufacture and cannot be adjusted according to user needs, the mixing device and mixing system of the present disclosure can achieve better and more appropriate fluid mixing effects. Also, by freely adding or removing mixing elements in the fluid pipe, the mixing rate can be further adjusted. Further, the combination aspects of the various mixing elements in the mixing device of the present disclosure are diverse, and different combination types of multiple groups of mixing elements can be adjusted according to the properties of the fluid to effectively achieve the most optimal mixing effect.

Furthermore, the mixing effect of the conventional mixing system occurs in the mixing tank. Therefore, the conventional mixing system has no mixing effect in the pipe, and the mixing rate naturally cannot be changed before entering the mixing tank. The mixing device and mixing system provided by the present disclosure can mix the fluid in advance in the front-end pipe with a mixing device including a passive shaking deflector, etc., combined with the technical means to freely increase the combination aspect and combination number of mixing-related elements, a high mixing rate can be achieved before the fluid enters the actual mixing tank, and then enters the mixing tank for final mixing.

While the present disclosure has been described by means of specific embodiments, those skilled in the art should understand that the embodiments are only used to illustrate the present disclosure and should not be interpreted as limiting the scope of the present disclosure. It should be noted that all equivalent changes and substitutions to the embodiments should be considered to be within the scope of the present disclosure, and the above-mentioned embodiments can be combined and transformed in any way. Therefore, the protection scope of the present disclosure is defined by the claims.

While the present disclosure has been described by means of specific embodiments, numerous modifications and variations could be made thereto by those skilled in the art without departing from the scope and spirit of the present disclosure set forth in the claims.

What is claimed is:

1. A mixing device, comprising:
a fluid input portion, suitable for receiving at least one fluid to be mixed, the fluid input portion comprising:
at least one fluid input pipe; and
a fluid mixing portion, communicated to the fluid input portion, the fluid mixing portion comprising
a fluid mixing pipe, communicated to the at least one fluid input pipe; and
a passive shaking deflector, arranged in the fluid mixing pipe;
wherein the passive shaking deflector is driven to shake by the fluid to be mixed flowing through the passive shaking deflector.

2. The mixing device according to claim 1, wherein the passive shaking deflector comprises:
a supporting base, disposed on a wall of the fluid mixing pipe; and
a shaking spoiler, connected to the supporting base;
wherein the volume of the shaking spoiler is larger than the volume of the supporting base, and the shaking spoiler has a larger fluid contact area compared to the supporting base.

3. The mixing device according to claim 2, wherein the shaking spoiler comprises:
a front spoiler end, proximal to a location where the at least one fluid to be mixed is received; and
a back spoiler end, distal to the location where the at least one fluid to be mixed is received;
wherein in a direction from the front spoiler end toward the back spoiler end, the shaking spoiler has a first arc surface with a gradually expanding thickness and a second arc surface with a gradually shrinking thickness that is continuous with the first arc surface on at least one side.

4. The mixing device according to claim 2, further comprising:
a fixed deflector, disposed in the fluid mixing pipe and is adjacently spaced apart from the passive shaking deflector.

5. The mixing device according to claim 4, wherein there are two passive shaking deflectors, respectively adjacently spaced apart from both sides of the fixed deflector.

6. The mixing device according to claim 5, wherein the shaking spoiler comprises:
a front spoiler end, proximal to a location where the at least one fluid to be mixed is received; and
a back spoiler end, distal to the location where the at least one fluid to be mixed is received;
wherein in a direction from the front spoiler end toward the back spoiler end, the shaking spoiler has a first arc surface with a gradually expanding thickness and a second arc surface with a gradually shrinking thickness that is continuous with the first arc surface on at least one side.

7. The mixing device according to claim 6, wherein the first arc surface and the second arc surface are formed on a side of the shaking spoiler adjacent to the fixed deflector.

8. The mixing device according to claim 6, wherein the first arc surface and the second arc surface are formed on a side of the shaking spoiler away from the fixed deflector.

9. The mixing device according to claim 1, wherein there are a plurality of passive shaking deflectors, and arranged linearly adjacent or surrounding the fluid mixing pipe.

10. The mixing device according to claim 1, wherein the passive shaking deflector is removably mounted on the fluid mixing pipe.

11. The mixing device according to claim 10, wherein the fluid mixing pipe has at least one slot configured to accommodate and fix the supporting base of the passive shaking deflector.

12. The mixing device according to claim 1, wherein at least a portion of the fluid mixing pipe is removable.

13. A mixing system, comprising:
a mixing tank;
at least two mixing devices as claimed in claim 1;
wherein the fluid mixing portions of the at least two mixing devices are communicated to the mixing tank via at least two openings,
wherein the opening axis directions of the at least two openings are non-coaxial with each other.

14. The mixing system according to claim 13, wherein the opening axis directions of the at least two openings are located on opposite sides of the center of the mixing tank.
